(19) United States
(12) Patent Application Publication
(10) Pub. No.: US 2014/0002473 A1
(43) Pub. Date: Jan. 2, 2014

(54) Brightness Control Method, Apparatus and Program Product

(71) Applicants: John Carl Mese, Cary, NC (US); Nathan J. Peterson, Durham, NC (US); Russell Speight VanBlon, Raleigh, NC (US); Rod D. Walterman, Rougemont, NC (US)

(72) Inventors: John Carl Mese, Cary, NC (US); Nathan J. Peterson, Durham, NC (US); Russell Speight VanBlon, Raleigh, NC (US); Rod D. Walterman, Rougemont, NC (US)

(73) Assignee: LENOVO (SINGAPORE) PTE LTD, Singapore (SG)

(21) Appl. No.: 13/535,992

(22) Filed: Jun. 28, 2012

(51) Int. Cl. G09G 5/02

(52) U.S. Cl. 345/589

(57) ABSTRACT

A method, apparatus and program product which enable a user selected display brightness to be linked to an application program selected for use in an electronic device such as a computer system, tablet, telephone, electronic book reader, game device, music playing device and the like. A user selected adjustment of display brightness for an application program and a then existing ambient lighting condition are stored in memory during use of the application program. In response to subsequent opening of an application program for which data has been stored, the stored data is accessed and display brightness relative to the ambient lighting condition present at the subsequent opening is given the previous, stored, user selected adjustment.

### FIELD AND BACKGROUND

A user's experience with electronic devices such as computer systems, tablets, telephones, electronic book readers, game devices, music playing devices and the like is impacted by the brightness of the display provided. Many such devices provide ambient light condition sensors and circuitry and executing program code which adjust brightness in response to variations in such ambient lighting. Many such devices accept or provide program code enabling a range of activities such as word processing, internet access and searching, data capture for purposes of downloading program code and data such as web sites or electronic publications.

A user in exercising such program code, here as in common usage called application programs, may find that display brightness provided by the device is not the best for their individual viewing. For that reason, it is commonplace for the program code provided with or in the device to enable user adjustment of display brightness. Usually such functionality is provided at the operating system code level. Using this functionality, a user may adjust the display brightness while using an application program to adapt the device to the user's preferences. However, such adjustments must be made for each application program and each time that the application program is initiated.

### SUMMARY

What is disclosed and taught in the description which follows are a method, apparatus and program product which enable a user selected display brightness to be linked to an application program selected for use in a device of the types mentioned above. In particular, a user selected adjustment of display brightness for an application program and a then existing ambient lighting condition are stored in memory during use of the application program. In response to subsequent opening of an application program for which data has been stored, the stored data is accessed and display brightness relative to the ambient lighting condition present at the subsequent opening is returned to the previous, stored, user selected adjustment.

### BRIEF DESCRIPTION OF DRAWINGS

Some purposes having been stated, others will appear as the description proceeds, when taken in connection with the accompanying drawings, in which:

FIG. 1 is an example of a computer system in which the technology described here may be implemented;

FIG. 2 is a flow chart showing an implementation of the technology here described; and

FIG. 3 is a representation of a tangible computer readable medium bearing executable program code which will implement the techniques here described.

### DETAILED DESCRIPTION

While the present technology will be described more fully hereinafter with reference to the accompanying drawings, in which preferred embodiments are shown, it is to be understood at the outset of the description which follows that persons of skill in the appropriate arts may modify what is here described while still achieving the favorable results contemplated. Accordingly, the description which follows is to be understood as being a broad, teaching disclosure directed to persons of skill in the appropriate arts, and not as limiting upon the scope of the claims.

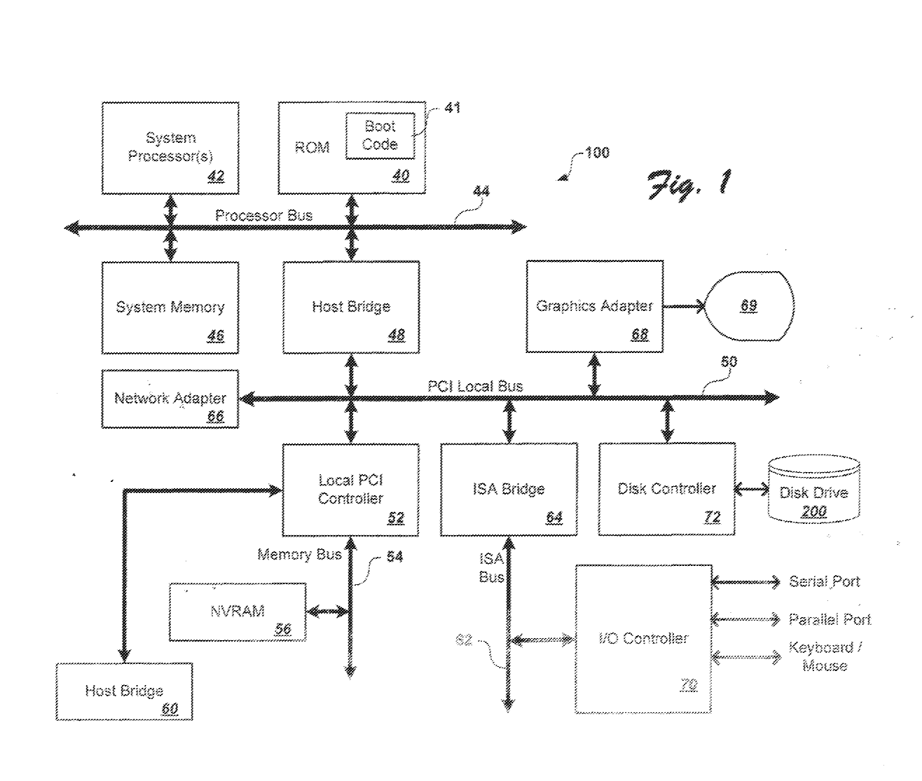

Referring now to FIG. 1, what is there shown and will be here described is an example of an electronic apparatus, in particular a computer system, useful in practicing this technology. It will be understood by knowledgeable readers that computer systems vary in complexity, size and capability. The showing and description here should thus be understood as an example only. It is contemplated that the techniques will be implemented through the available range of computing apparatus and related devices as mentioned above.

FIG. 1 is a block diagram of a computer system 100 according to an embodiment of the present technology which incorporates at least one system processor 42, which is coupled to a Read-Only Memory (ROM) 40 and a system memory 46 by a processor bus 44. System processor 42 is a general-purpose processor that executes boot code 41 stored within ROM 40 at power-on and thereafter processes data under the control of operating system and application programs stored in system memory 46. System processor 42 is coupled via processor bus 44 and host bridge 48 to Peripheral Component Interconnect (PCI) local bus 50.

PCI local bus 50 supports the attachment of a number of devices, including adapters and bridges. Among these devices is network adapter 66, which interfaces computer system 100 to LAN 10, and graphics adapter 68, which interfaces computer system 100 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system 100 further includes Industry Standard Architecture (ISA) bus 62, which is coupled to PCI local bus 50 by ISA bridge 64. Coupled to ISA bus 62 is an input/output (I/O) controller 70, which controls communication between computer system 12 and attached peripheral devices such as a keyboard, mouse, and a disk drive. In addition, I/O controller 70 supports external communication by computer system 100 via serial and parallel ports.

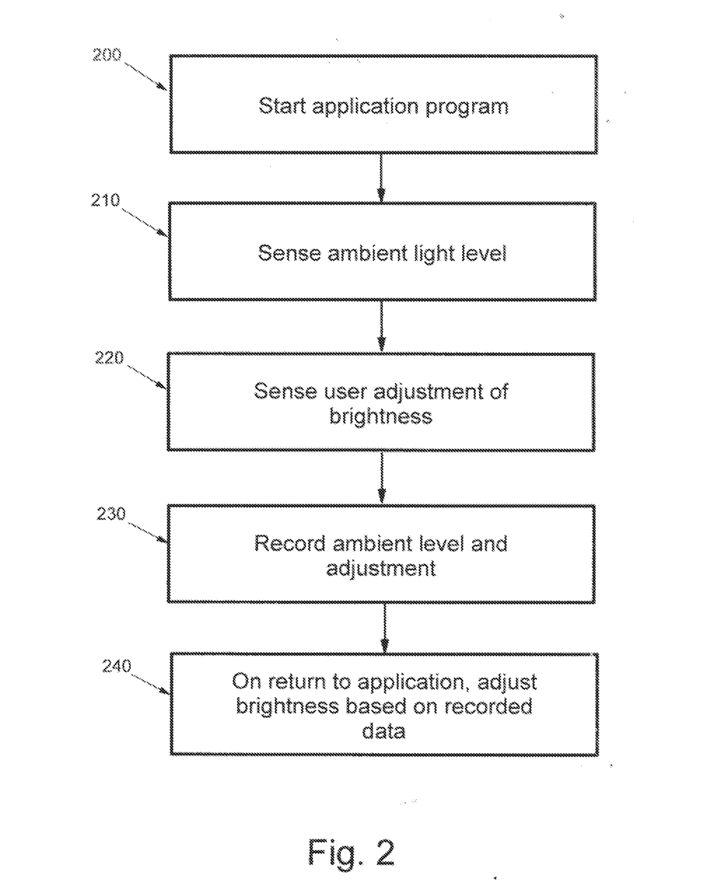

Referring now to FIG. 2, a sequence which follows the execution of the method of this technology in an apparatus of the types described is there shown. On a user starting an application program (200), the device used will sense ambient light conditions (201). In the event that the user makes any adjustment of the brightness level of the display, toward increased or decreased brightness, that adjustment is sensed (202). The ambient light conditions existing at startup of the application program and the user adjust of brightness are recorded in the device memory in a form accessible to the device processor, such as a data base of application programs, sensed ambient conditions, and sensed user adjustments (203). On a return to use of the application program at some later time, display brightness will be adjusted to the recorded user preference taking into account the ambient lighting conditions at the time of return to the program.

User adjustment may be done in a number of varying ways, depending on choices made available through the operating system design. In one embodiment, the user adjustment may be by steps, such as an increase or decrease by 10%, 20%, 30% etc. In an alternate embodiment, the user adjustment may be along a continuum, with simple selection of a point along a range of from dim to very bright. In yet another embodiment, the user adjustment may be as a percentage of ambient light sensed. Further, in any of these embodiments the user adjustments, which may vary from time to time regardless of ambient lighting conditions due to variations in user preference, can be gathered over the passage of time, resulting in generation of a light curve unique to each application program and applied automatically. As the user continues to make adjustments, the light curve becomes more accurate increasing viewer comfort and potentially lowering the discharge rate of any battery supporting operation of the device. It is contemplated that, in response to opening of an application program for which data defining any user selected adjustment of display brightness is absent, the device will select a brightness level appropriate to the then present ambient lighting condition. Should the user then make an adjustment in display brightness, then the process described here would begin.

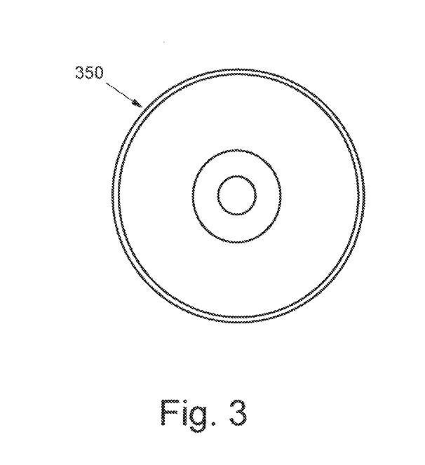

Referring now to FIG. 3, one or more aspects of the present technology can be included in an article of manufacture (e.g., one or more computer program products) having, for instance, tangible computer usable media, indicated at 350 in FIG. 3. The media has embodied therein, for instance, computer readable program code for providing and facilitating the capabilities of the methods and apparatus described. The article of manufacture can be included as a part of a computer system or sold separately. Machine readable storage mediums may include fixed hard drives, optical discs such as the disc 350, magnetic tapes, semiconductor memories such as read only memories (ROMs), programmable memories (proms of various types), flash memory, etc. The article containing this computer readable code is utilized by executing the code directly from the storage device, or by copying the code from one storage device to another storage device, or by transmitting the code on a network for remote execution.

In the drawings and specifications there has been set forth preferred embodiments of the technology and, although specific terms are used, the description thus given uses terminology in a generic and descriptive sense only and not for purposes of limitation.

What is claimed is:

1. A method comprising:
storing in a memory data defining (a) any user selected adjustment of display brightness for an application program during use of the application program and (b) a then existing ambient lighting condition; and
in response to subsequent opening of an application program for which data has been stored, accessing the stored data and returning to the user selected adjustment of display brightness relative to the ambient lighting condition present at the subsequent opening.

2. A method according to claim 1 wherein the stored data records the user selected adjustment of brightness relative to the then existing ambient lighting condition.

3. A method according to claim 2 wherein the user selected adjustment of brightness is by selection of one of a number of discrete steps of brightness levels.

4. A method according to claim 2 wherein the user selected adjustment of brightness is by selection of a point along a continuum of brightness levels.

5. A method according to claim 1 further comprising in response to opening of an application program for which data defining any user selected adjustment of display brightness is absent, selecting a brightness level appropriate to the then present ambient lighting condition.

6. A method according to claim 1 further comprising accumulating stored data regarding ambient lighting conditions and user adjustments in display brightness over time, generating a response curve demonstrative of user adjustments over varying ambient lighting conditions, and referencing the generated response curve in returning to user selected adjustment of display brightness.

7. An apparatus comprising:
a computer system having a processor and memory accessible to the processor; and
executable program code including an application program stored in said memory accessibly to the processor;
the program code when executed by said computer system:
storing in the memory data defining (a) any user selected adjustment of display brightness for an application program during use of the application program and (b) a then existing ambient lighting condition; and
in response to subsequent opening of an application program for which data has been stored, accessing the stored data and returning to the user selected adjustment of display brightness relative to the ambient lighting condition present at the subsequent opening.

8. An apparatus according to claim 7 wherein the stored data records the user selected adjustment of brightness relative to the then existing ambient lighting condition.

9. An apparatus according to claim 8 wherein the user selected adjustment of brightness is by selection of one of a number of discrete steps of brightness levels.

10. An apparatus according to claim 8 wherein the user selected adjustment of brightness is by selection of a point along a continuum of brightness levels.

11. An apparatus according to claim 7 wherein in response to opening of an application program for which data defining any user selected adjustment of display brightness is absent, selecting a brightness level appropriate to then present ambient lighting condition.

12. An apparatus according to claim 7 wherein stored data regarding ambient lighting conditions and user adjustments in display brightness is accumulated over time, a response curve demonstrative of user adjustments over varying ambient lighting conditions is generated, and the generated response curve is referenced in returning to user selected adjustment of display brightness.

13. A program product comprising:
a tangible computer readable medium; and
program code stored on said tangible computer readable medium accessibly to a computer system which has a processor, memory accessible to the processor, and data stored in said memory, said program code when accessed by and executed on a computer system:
storing in the memory data defining (a) any user selected adjustment of display brightness for an application program during use of an application program and (b) a then existing ambient lighting condition; and
in response to subsequent opening of an application program for which data has been stored, accessing the stored data and returning to the user selected adjustment of display brightness relative to the ambient lighting condition present at the subsequent opening.

14. A program product according to claim 13 wherein the stored data records the user selected adjustment of brightness relative to the then existing ambient lighting condition.

15. A program product according to claim 14 wherein the user selected adjustment of brightness is by selection of one of a number of discrete steps of brightness levels.

16. A program product according to claim 14 wherein the user selected adjustment of brightness is by selection of a point along a continuum of brightness levels.

17. A program product according to claim 13 wherein in response to opening of an application program for which data defining any user selected adjustment of display brightness is absent, selecting a brightness level appropriate to then present ambient lighting condition.

18. A program product according to claim 13 wherein stored data regarding ambient lighting conditions and user adjustments in display brightness is accumulated over time, a response curve demonstrative of user adjustments over varying ambient lighting conditions is generated, and the generated response curve is referenced in returning to user selected adjustment of display brightness.
